(19) United States
(12) Patent Application Publication
(10) Pub. No.: US 2007/0226055 A1
(43) Pub. Date: Sep. 27, 2007

(54) Incentive system and method for tracking advertising effectiveness

(75) Inventors: Roger Robert Belanger, Dover, NH (US); Thomas Bowen Clarke, Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/387,953

(22) Filed: Mar. 23, 2006

(51) Int. Cl. G06Q 30/00

(52) U.S. Cl. 705/14

(57) ABSTRACT

A method for tracking advertising effectiveness includes causing an advertising code with an advertisement to be printed, the advertising code identifying the advertisement, the advertising code capable of being scanned by a handheld device of a potential customer. The potential customer is then provided with an incentive to scan the advertising code, a value of the incentive being stored on the handheld device. Information is received on the advertising code scanned by the potential customer and as a consequence reducing the value of the incentive stored on the handheld device. A handheld device and system are also provided.

The present invention relates generally to printed materials with advertising and to handheld devices such as scanners for scanning printed materials.

U.S. Pat. Nos. 6,448,979 and 6,753,883, both hereby incorporated by reference herein, describe printed medium activated interactive communication of multimedia information, including advertising. A scanner and a receiver, which may be a single device, communicate with a portal server to play multimedia sequence information received from the portal server. Advertisements may be printed with a machine readable code such as a barcode including a high density bar code and the data from the code may be read by the scanner. The code contains link information corresponding to provider information and may be an alphanumeric sequence. The sequence may activate and result in the playing of multimedia sequence information. The scanner the receiver or the portal server can translate the link information into a network address, so that the multimedia sequence information can be played. Additionally or in the alternative, the network address information can point to a file containing executable computer code and displayed on the receiver or scanner. The system contemplates using additional code types such as benefit redemption information, rebate information and coupon information. The system may also collect and manage code that lacks link information, such as a UPC code. The person can take the UPC information home and get information on the product, a coupon, or other benefit redemption information.

User input information may be stored in the scanner memory. A communications bridge can send the link information and the user input information to the receiver and via a network to the portal server. The system also is capable of allowing print advertisers to track their impressions to execution and to collect demographic information about the person performing the scan through a tracking module. The tracking module is further capable of tracking the transaction value of e-commerce transactions originating from a specific publication, type of publication, or provider and calculate fee percentages based on the transaction. The scanner may have clock which can track the time the ad was scanned.

U.S. Pat. No. 6,896,182 is also incorporated by reference herein and describes a card verification system in which a card identification code is registered. A read unit reads the card identification code from the card. A verification apparatus verifies the card only when an existing place of the read unit belongs to an area corresponding to the card identification code. The card is a card used for settlement, and is used when the card identification code is read by the read unit. The use place of the card is coincident with the existing place of the read unit. By adding the use place of the card to a verification condition of the card, unjust use of the card can be prevented. This patent also describes a mobile remote operation point-of-sale terminal as disclosed in Japanese Laid Open Patent Application (JP-A-Heisei 11-500550). In an accounting system, a portable radio accounting terminal is provided in which a user inputs transaction data of dealings using keypad, a UPC bar code of the goods is read by a CCD sensor, a credit card, a debit card and a smart card of the user can be read. The portable radio accounting terminal transmits the dealings and card data to a central network controller via a radio communication network. The central network controller transmits to the host computer in the accounting facilities which processes the card data and the dealings in real time in order. The accounting facilities sends back confirmation data to the central network controller and send back to the radio accounting terminal via the radio communication network. Thus, the radio accounting terminal issues the printed receipt of the dealings to the user.

FIG. 1 describes the existing coupon redemption system for clipped coupons used in the food industry. A manufacturer 10 of a good 12 sends the goods to a retailer 14 and sends coupon information to a coupon agent 16. The coupon agent 16 provides design and printing services as indicated generally at 20, with a customer or consumer 22 clipping or collecting the printed coupons. The customer then redeems the coupons at the retailer 14. A checkout device scans the coupons barcode and compares the coupons with a database of the food market or other industry 24. Retailer 14 sends the paper coupons to a clearinghouse 26, which provides feedback to the coupon agent 16. The feedback can provide advertising information such as identifying the advertisement where the coupon was clipped and limited information on the consumer. The manufacturer, also an advertiser, thus can obtain some information on the effectiveness of its printed coupon advertisements.

### SUMMARY OF THE INVENTION

The present invention provides a method for tracking advertising effectiveness comprising:

printing advertising data with an advertisement, the advertising data identifying the advertisement, the advertising data capable of being scanned by a handheld device of a potential customer;

providing the potential customer with an incentive to scan the advertising data, a value of the incentive being stored on the handheld device; and

receiving information on the advertising data scanned by the potential customer and as a consequence reducing the value of the incentive stored on the handheld device.

By providing an incentive stored at the handheld device, the customers can easily provide the advertising data while receiving benefits.

The present invention also provides a handheld device for an incentive to be redeemed by a user comprising:

a scanner for scanning printed advertising data;

a memory for storing the advertising data and user or device identification data, an incentive value being a function of the stored advertising data;

a communications interface;

a processor sending a portion of the advertising data via the communications interface and reducing the incentive value as a function of the sent portion of the advertising data.

The present invention also provides a system for tracking advertising effectiveness comprising:

a plurality of the handheld devices of the present invention;

an incentive tracking device receiving the portions of the advertising data and providing benefits to the users of the handheld devices as a function of the reduced incentive values.

The present invention provides a handheld device comprising:

a scanner for scanning printed advertising data;

a memory for storing the advertising data and user or device identification data;

a processor for providing a value as a function of the advertising data; and

a communications interface;

the processor reducing the value or deleting a portion of the advertising data from the memory and sending the portion or another portion of the advertising data over the communications interface as a function of an input from the communications interface or an input from a user of the handheld device.

By providing a processor with a debit or delete function at the handheld device for scanning advertising data, a user can be provided various valuable incentives to provide information. Incentives can be handled via the handheld device itself.

### BRIEF DESCRIPTION OF THE DRAWINGS

FIG. 1 shows a prior art coupon clearinghouse system.

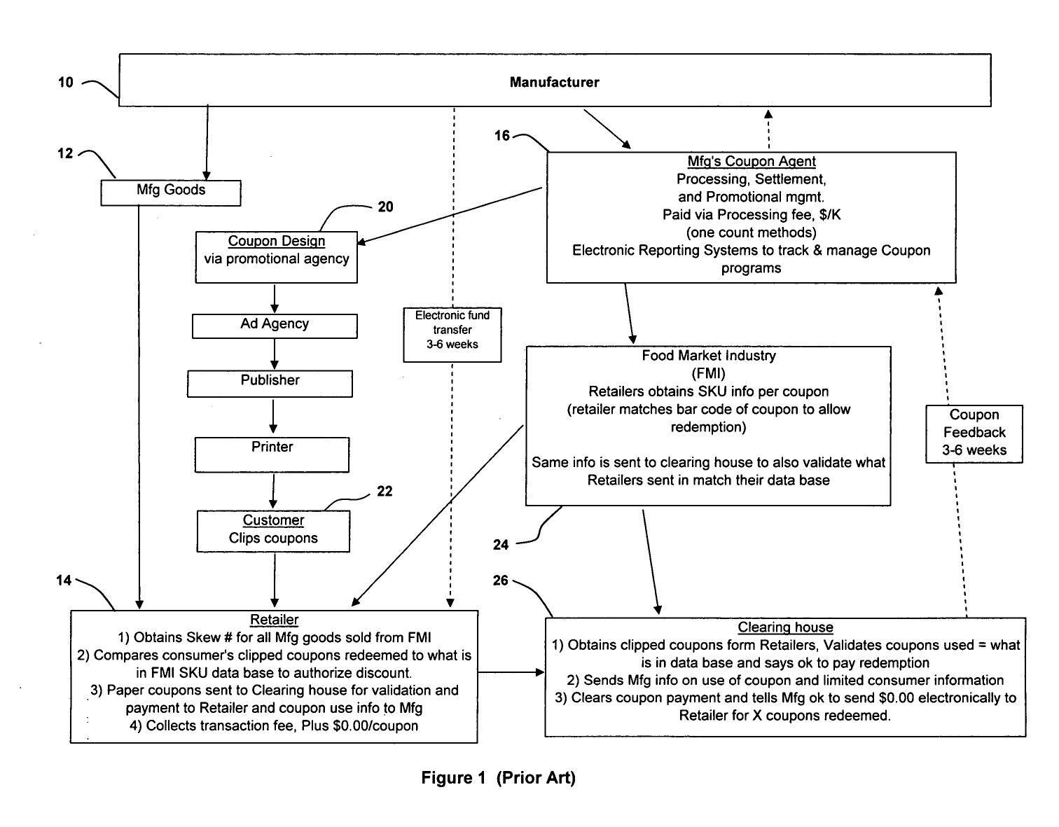

The present invention will be described further with respect to the drawings in which:

FIG. 2 shows a schematic of one embodiment of a system of the present invention;

FIG. 3 shows a flowchart of one embodiment of a method of the present invention; and

FIG. 4 shows one embodiment of the handheld device of the present invention.

### DETAILED DESCRIPTION

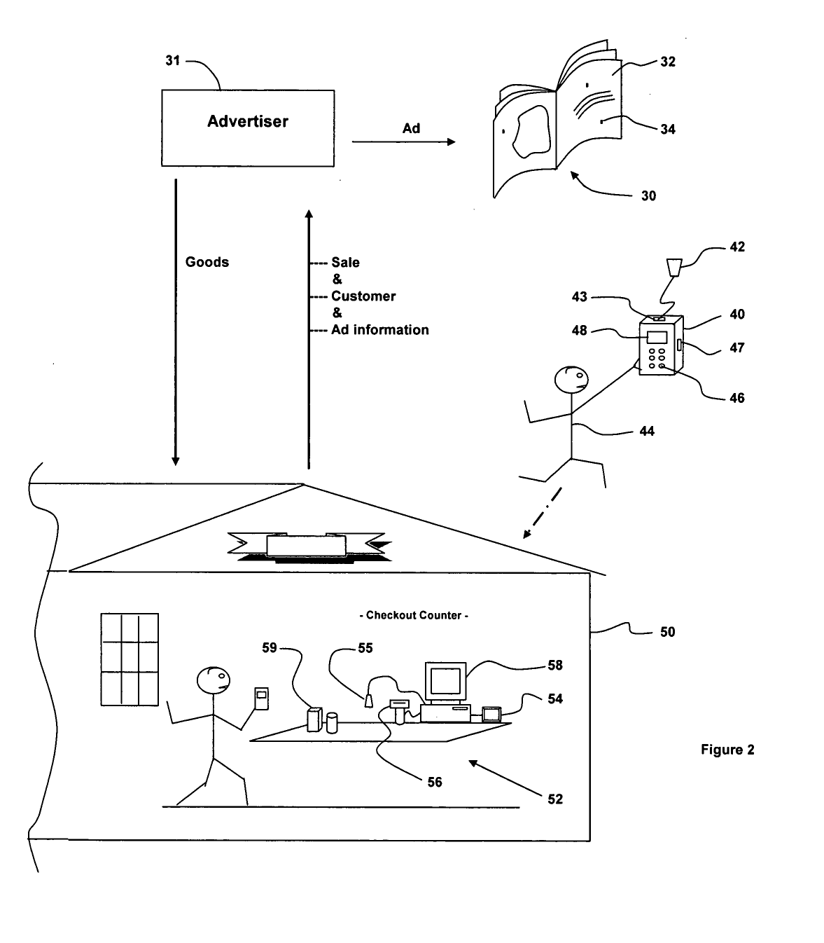

FIG. 2 shows a general overview of one embodiment of the present invention. An advertisement 32 from an advertiser 31 is printed for example in a magazine 30. Advertising data 34, such as the magazine name, page and advertiser identification information can be provided, for example in a code form as described in incorporated by reference U.S. Pat. No. 6,448,979. A potential customer 44 has a handheld device 40 for example an IPOD from Apple, or cell phone, the handheld device having a detachable scanner 42 capable of scanning the printed advertising data 34 and inputting the advertising data into a memory of the handheld device 40. The scanner 42 may be attached via an interface 43.

At a store 50, for example a supermarket, electronics goods store or boat or automobile sales store, the user can select a good or goods to purchase and then checkout at a checkout device 52, which may for example simply be a sales office in a store selling larger goods, or a supermarket checkout counter or any other store location where the customer typically provides payment information.

Checkout device 52 is provided with a communications interface 54 to read the advertising data from the handheld device 40 of the customer 44. The advertising data includes an incentive value such as a coupon, or points for a loyalty program, such as TIMESPOINTS from the New York Times, or a CVS Store EXTRACARE. Such a loyalty program preferably is run by the advertiser, the advertisement publisher, or the store 50. Coupons typically but not necessarily are provided by the advertiser. Such incentives provide an incentive for the customer 44 to provide the advertising data in the handheld device 40 to the checkout device 52 at checkout.

The checkout device 52 also typically has a payment device 56, such as a debit or credit card reader. This payment device 56 can provide limited user information. The interface 54 and payment device 56 can be integrated into a single device.

The checkout device communications interface 54 may for example read advertising data from the handheld device 40 via a communications interface 47, which for example can support Bluetooth, infrared or a smart card technology. It is noted that the handheld device at this point need not have the scanner 44. Interface 47 and interface 43 could be one interface as well.

There are two ways in this embodiment that the advertising data is sent to the checkout device 52 from the handheld device 40.

First, the customer 44 can scroll via an input device 46 on the handheld device 40 through the stored advertising data, for example via display information shown on a display 48. The display information is a function of the advertising data, and additional information may be obtained for example through interface of the handheld device with a server having display information. For example, the customer via their home computer and the internet could send the limited scanned advertising data to the server and in return receive single media display information such as an image of an actual coupon or the product in the advertisement. In this embodiment, multimedia information typically is not desired as taking up too much memory and space.

The customer 44 can then select advertising data 34 related to a good 59 being physically purchased at checkout in the store 50, the customer 44 leaving the store 50 with the good 59. The customer then can push a button on the input device 46 to send the advertising data to the checkout interface 54, which can then provide the information to a checkout processor 58. The checkout processor 58 can determine for example if the customer is entitled to a rebate for the good 59 and apply the rebate so that at the payment device 56 the customer 44 pays less for the good 59. The identification of good 59 can occur for example via a barcode reader 55, or input by a store employee. User information or a device ID can be provided via the handheld device 40 and/or by the payment device 56. In addition, the rebate amount can be altered by either the handheld device 40 or checkout device 52, as a function of the information the customer is willing to provide. For example, if the customer 44 provides information on his or her home address, a coupon value can be increased. The customer thus can control the advertising and user or device data sent.

The second way the advertising data can be sent is that the good(s) 59 are scanned via the barcode scanner 55 or good information is entered into checkout device 52 by a store employee, and then the checkout device 52 retrieves the advertising data in the handheld device 40 related to the scanned good information. Such a comparison of the scanned good information and advertising data can take place in the handheld device 40 or the checkout device 52 for example. Since the advertising data may contain UPC code information on the advertised product, the comparison could be a simple numerical matching operation.

Advertising data related to the scanned good information then could be sent via the checkout device 52 together with user or device information and the sales information of the good can be sent to the advertiser 31.

Advertiser 31 can then determine the effectiveness of the advertisement 32, and the incentive information associate therewith. For example, the advertiser of a cereal could print 10,000 ads stating that a scan will be worth 10 loyalty points or provides a coupon worth 1 dollar, and 10,000 ads stating that a scan will be worth 20 loyalty points or provides a coupon worth 2 dollars, and provide advertising data indicating which of the ads are worth 10 points and which are worth 20 points. The advertiser can then see if the value change alters the response rate to the ads. Moreover, even if the incentives are all the same, the advertiser 31 can track sales at various stores 50. Store information also can be provided to the advertiser 31, so that the advertiser knows where the goods are purchased.

This information is of enormous value to many advertisers and to date has not been captured except via clipped coupons, which are cumbersome and require a large UPC code to be printed and for the customer to clip the coupons. The present invention permits excellent incentive for a customer to provide advertising data. Feedback from the coupon or loyalty programs can be almost instantaneous. Response rates to such ads can be determined at almost all points of sales, and the present invention can be used in conjunction with e-commerce sales or coupon clipping programs.

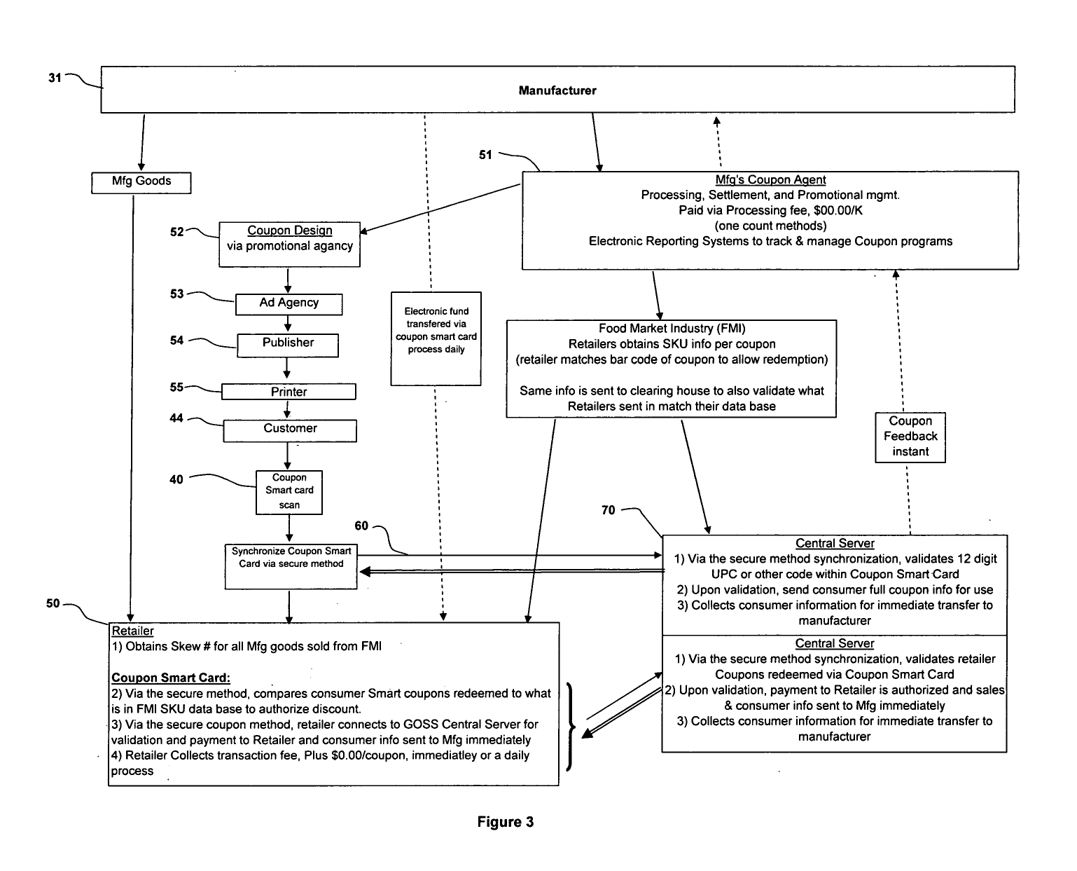

FIG. 3 shows for example one embodiment of a coupon redemption method for the food market industry using a central server. The advertiser 31, here a food goods manufacturer, provides goods to the store 50, which obtains SKU (stock keeper unit) numbers for all the goods. The advertiser 31 also causes the coupon to be printed with an advertisement in steps 52, 53, 54, 55, via a coupon agent 51.

The customer 44 scans the ads with the handheld device 40, here a device which defines a coupon smart card, to obtain the advertising data, which includes the coupon data. In an optional step, the advertiser can require that the coupon data be validated for example via a home computer and internet link 60 to a central server 70. At that point, the advertising data can be collected and forwarded to the agent 51, and the coupon can be validated (for example by checking against a database of issued coupons and providing a validation code which can be stored in the handheld device) for full use. The advertising data may be provided with or without user data or device ID data as determined by the customer, for example by pushing input buttons to a query of the handheld device as to whether the information should be provided. Display information, additional discounts or promotions to increase the coupon value or other information can be sent to the handheld device for viewing and/or validation of the coupon.

The consumer 44 can then shop at the retailer 50 and upon checkout, can provide the handheld device 40 with the scanned coupons and receive the rebate as described above. The coupon at this point can be validated or revalidated by the central server 70, for example by checking the expiration date and providing the retailer 50 a validation code. The central server 70 at this time collects the advertising data and user or device ID information, and sales data and store data, for transfer to the agent 51. Feedback advantageous for determining ad effectiveness can occur immediately after checkout. The agent 51 can then provide this information to the advertiser 31 and modify the advertising in response to response rates, for example.

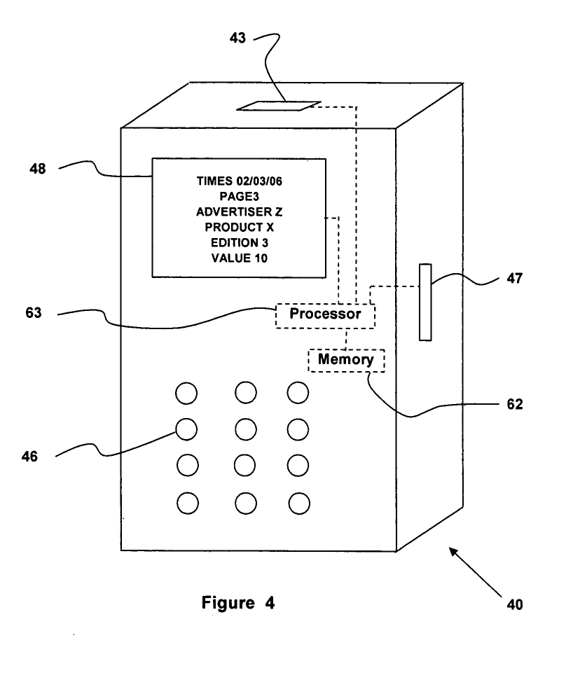

FIG. 4 shows schematically an embodiment of customer handheld device 40 for use at a store checkout, having an input device 46, a display 48, an interface 43 for a scanner for scanning printed advertising data, a memory 62 for storing the advertising data, a processor 63 for receiving input data from the input device and providing the display with display information related to the advertising data, and a communications interface 47 for interacting with a store checkout device and the processor 63. While the display in FIG. 4 is showing the actual advertising data, typically only a part of the data, or display data received from the central server will be displayed, such an image of a coupon similar to coupons clipped from newspapers.

The processor 63 runs a software program, which has steps permitting input of the scanned advertising data and storage in the memory, as well as for the inputting and storing of user or device information. It also may have comparison steps for comparing the stored data with data from the checkout processor and comparison with data input by a user.

The customer can enter in user data for example name, home address, telephone and other contact information into the device 40 via input device 46, for example keys on a cell phone. A personal security code can also be entered and stored.

As one specific example, an advertisement for a cereal brand can be printed with the scannable image TIMES Feb. 3, 2006 PAGE 3 ADVERTISER Z PRODUCT X EDITION 3 VALUE 10 indicating that Advertiser Z, the cereal manufacturer, had an ad printed in the New York Times on Feb. 3, 2006 on page 3 for product X. The ad was a third edition for that product X, and provided a coupon value of 10 indicating 10 cents off. Obviously a simpler alphanumeric sequence could provide similar information, and can be provided for example via a two-D bar code to minimize space and visual impact.

The customer scans the advertising data when he or she reads the Times, the data then being stored in the handheld device 40. Previously, the customer may have entered in, as a non-limiting example, his or her name, address, telephone number, age and e-mail address or other personal information into the handheld device 40.

At a store, the customer remembers the product X cereal and decides to buy it, and proceeds to the checkout counter. At the checkout, a store employee scans the barcode for product X, which permits the checkout processor to know that product X is being purchased. The customer then states that he has the handheld device 40 and the store employee presses a button to run a coupon check via the checkout device 52 via the interfaces 47, 54. The word “product X” or similar ID is presented to the handheld device, which via its processor 63 then matches this word with the advertising data for product X and sends the product X advertising data to the checkout device 52, which indicates a rebate of 10 cents. The advertising data can be sent to a central server, which verifies that such a coupon value was provided in the advertisement on the proper date and that the coupon has not expired, and a verification code can be sent to processor 58, which upon receipt provides the rebate of 10 cents. The payment device thus requires a payment of 10 cents less. At this point or earlier, the customer also can be queried, for example by the store employee, if he or she would like provide customer information from a credit card or from the handheld device for a larger. The size of the rebate can depend on the amount of information the customer is willing to provide, for example e-mail only, or e-mail and name. A security code for example can be entered by the customer to permit this information to be transferred to the checkout device 52. The security code could also be required before providing the advertising data. The customer then can pay and leave the store. The advertiser can receive the advertising data, customer information and store information either upon coupon validation or after payment. The store will then receive coupon reimbursement and a processing fee from the advertiser, for example through an electronic fund transfer as shown in FIG. 3.

Once the advertising data is sent to the checkout device 52, the advertising data is erased, or the coupon value is set to zero on device 40 so that the coupon cannot be redeemed again. This value reduction can occur via a command sent by the checkout device 52, or can occur automatically when the user sends the advertising data if this is how the data is sent. The reduction of the value can also occur within the central server or checkout device if a device ID or customer ID is provided every time the handheld device is used, so that while the advertising data remains on the handheld device 40, the coupon cannot be used again as the checkout device and/or central server know that that device or customer has previously used that coupon. The central server thus can store each coupon and device ID for example to prevent duplication. The coupons also can be erased upon a coupon expiration date checked against a clock of the handheld device or a clock of the checkout device or central server. Notification via the handheld device display of a nearing expiration date, for example, two days prior to expiration, cane sent by the program in the processor.

The program in the processor of the handheld device also can block a duplicate scan so that the incentive is not increased upon the duplicate scan, or that the second coupon or incentive is not stored, or can prompt the customer to accept the duplicate scan.

The scannable machine readable data 34 may for example provide full value of a manufacturer's coupon if used within its expiration date. An advantageous method of the present invention is to add value to coupons which may not be redeemed by their expiration date. Typically coupons are sent out by manufactures on their sales and promotional schedules, which may or may not coincide with the customer's desire to buy a product at the time they receive the advertisement in their mail. Therefore the opportunity for the manufacturer to receive customer information and the incentive for the customer to scan the coupon is lost. Thus the printed coupon is dead, or is thrown out and added no value to either the manufacturer who paid for it, or the consumer who paid for the magazine or newspaper. The program within the handheld device can therefore be programmed to have decrementing coupon value beyond the manufacturer's expiration date or be able to turn the expired coupon into loyalty points. By so doing, the incentive for the customer to scan a coupon with the chance he may not use it by its expiration date is maintained and the manufacturer improves their chance to obtain customer information.

All types of coupon incentives can be made variable or scaled or provided when certain thresholds or conditions are met. For example, coupons can be given a higher value for providing more consumer information, or for using the coupon at one store as opposed to another, so that for example a buyer of a certain cereal at WALMART is given a higher rebate that if the same cereal were purchased at COSTCO. This differentiation can be provided by the central server on validation before or at checkout for example, or within the advertising data itself.

In an alternate embodiment with loyalty points, as one specific example, an advertisement for a cereal brand can be printed with the scannable image TIMES Feb. 3, 2006 PAGE 3 ADVERTISER Z PRODUCT X EDITION 3 VALUE 10 indicating that Advertiser Z, the cereal manufacturer, had an ad printed in the New York Times on Feb. 3, 2006 on page 3 for product X. The ad was a third edition for that product X, and provided a loyalty points value of 10 indicating 10 TimesPoints for example, which can be redeemed via the New York Times website for various benefits. As an advantageous alternative, such loyalty points can be transferred from device 40 to the customer's TimesPoints loyalty program database if desired. Therefore device 40 can be used to collect advertisement data 34 from any manufacturer loyalty program, and have the ability to transfer them to their respective manufacturer's loyalty program. Another advantage of device 40 is to eliminate the multiple loyalty program cards customers carry. Therefore the device 40 can be either a storage medium, a pass thru device, or the loyalty card itself for multiple loyalty programs.

The customer scans the advertising data when he or she reads the New York Times, the data then being stored in the handheld device 40. The customer then for example via the handheld device, a PC and internet service provider can provide the Times website the advertising data, and have the 10 loyalty points validated for the customers account. At that point, the advertising data can be erased, or via device ID and user ID the Times website can deny further loyalty points from the same device user for the same advertisement scan. The Times can then provide the advertiser proof that the. advertisement was read and noticed by a customer. The present system advantageously can permit publishers to prove and measure which advertisements are being read, and thus prove advertising effectiveness.

The loyalty point amounts may also be made variable in a similar manner to the coupon amounts to provide scaled incentives.

The scanner may be integrated into the handheld device, and advantageously may be for example a camera of a mobile telephone.

The store or advertiser or other thus receive from the handheld device user valuable information, and in return provide a benefit to the handheld device user. The use of the benefit thus results in a reduction in value of the incentive stored on the handheld device, whether by directly reducing the value in the handheld device itself for example by erasing a coupon or reducing a point value, or by reducing the value indirectly for example by the checkout device or server not permitting the coupon stored in the handheld device to be used again.

What is claimed is:

1. A method for tracking advertising effectiveness comprising:
causing an advertising code with an advertisement to be printed, the advertising code identifying the advertisement, the advertising code capable of being scanned by a handheld device of a potential customer;
providing the potential customer with an incentive to scan the advertising code, a value of the incentive being stored on the handheld device; and
receiving information on the advertising code scanned by the potential customer and as a consequence reducing the value of the incentive stored on the handheld device.

2. The method as recited in claim 1 wherein the incentive is a coupon.

3. The method as recited in claim 1 wherein the incentive is a loyalty points program.

4. The method as recited in claim 1 wherein the value of the incentive stored on the handheld device is reduced by erasing or changing data on the handheld device.

5. The method as recited in claim 1 wherein the incentive includes a coupon, and further comprising setting an expiration date for the coupon so that the handheld device notifies the customer when the coupon is nearing the expiration date, and upon expiration the coupon is deleted or erased automatically.

6. The method as recited in claim 1 wherein the value of the incentive is time decremented to a lesser value, or converted into a different type of incentive.

7. The method as recited in claim 1 wherein the value of the incentive stored on the handheld device reduced by blocking duplicate use of the advertising code stored by a same device or user so that the incentive cannot be used more than once.

8. The method as recited in claim 1 wherein the handheld device blocks a duplicate scan so that the incentive is not increased upon the duplicate scan, or prompts the customer to accept the duplicate scan.

9. The method as recited in claim 1 wherein the incentive reduces a price of a good shown in the advertisement.

10. A handheld device for an incentive to be redeemed by a user comprising:
a scanner for scanning printed advertising data;
a memory for storing the advertising data and user or device identification data, an incentive value being a function of the stored advertising data;
a communications interface;
a processor sending at least a portion of the advertising data via the communications interface and reducing the incentive value as a function of the sent portion of the advertising data.

11. The handheld device as recited in claim 10 wherein the incentive value is a coupon value.

12. The handheld device as recited in claim 10 wherein the incentive value is a loyalty point value.

13. The handheld device as recited in claim 12 wherein the memory can store loyalty points for multiple loyalty programs and act as a loyalty card, or pass thru loyalty points to a computer.

14. A system for tracking advertising effectiveness comprising:
a plurality of the handheld devices as recited in claim 10;
an incentive tracking device receiving the portions of the advertising data and providing benefits to the users of the handheld devices as a function of the reduced incentive values.

15. The system as recited in claim 14 wherein the tracking device is a central server storing advertising data.

16. A handheld device comprising:
a scanner for scanning printed advertising data;
a memory for storing the advertising data and user or device identification data;
a processor for providing a value as a function of the advertising data; and
a communications interface;
the processor reducing the value or deleting a portion of the advertising data from the memory and sending the portion or another portion of the advertising data over the communications interface as a function of an input from the communications interface or an input from a user of the handheld device.

17. A method for tracking advertising effectiveness comprising:
causing an advertising code with an advertisement to be printed, the advertising code identifying the advertisement, the advertising code capable of being scanned by a handheld device of a potential customer;
providing the potential customer with an incentive to scan the advertising code, a value of the incentive being stored on the handheld device; and
receiving information on the advertising code scanned by the potential customer and providing the customer with a benefit related to the incentive, the benefit being redeemable using the handheld device.
